(19) United States
(12) Patent Application Publication
(10) Pub. No.: US 2022/0355462 A1
(43) Pub. Date: Nov. 10, 2022

(54) TOOL BOX

(71) Applicant: Yao-Lin Cho, Taichung City (TW)

(72) Inventor: Yao-Lin Cho, Taichung City (TW)

(21) Appl. No.: 17/692,189

(22) Filed: Mar. 11, 2022

Related U.S. Application Data
(63) Continuation-in-part of application No. 17/308,050, filed on May 5, 2021, now abandoned.

(51) Int. Cl. B25H 3/02; B25H 3/00

(52) U.S. Cl. CPC B25H 3/025; B25H 3/003

(57) ABSTRACT

A tool box includes a base and a cover which is mounted to the base so as to form a storage room in the tool box. At least one rack is pivotably connected between two facing inside walls of the base. Each rack includes multiple partitions for accommodating bits and accessories. The at least one rack can he pivoted relative to the base so that the users are easily pick the bits and the accessories.

### BACKGROUND OF THE INVENTION

### Fields of the Invention

This a Continuation-In-Part patent application of applicant's former patent application with application number 17/308,050, filed on May 5, 2021.

### Descriptions of Related Art

Hand tools such as screwdrivers, include different bits which have different shapes. The hand tools are used to tighten or loosen screws or nuts so that the users have to carry a tool box to prepare different hand tools and bits. The bits may include keystone tips, cabinet tips, Phillips tips, and square tips. Although the modern hand tool is designed to replace different tips, the tips are so small and can easily drop. Therefore, a proper tool box to organize and accommodate the hits and other accessories is needed.

USPN 2016/0052125 discloses a tool box with multiple racks pivotably connected between two facing inside wails of the tool box. The racks each have ribs extending from two ends thereof, and each of the two facing inside walls includes grooves defined therein, so that the ribs on two ends of each rack are engaged with the grooves of the tool box. However, once the grooves in the facing inside walls of the tool box are worn out by the ribs of the racks after frequent use, the racks cannot be positioned as desired, and the tool box has to be replaced.

U.S. Pat. No. 8,069,984 discloses a hit holder that includes V-shaped opening Formed to the holder so that the bit can be tilted and contacts the V-shaped opening. It is noted that the V-shaped opening is defined in the lateral side of the holder so that a portion close to the tip end of the bit is rested on the V-shaped face of the V-shaped opening. However, the length between the tip end to the portion that rested on the V-shaped face of the V-shaped opening is so short that the users may not easily to pick the bit.

The present invention intends to provide a tool box to meet the above-mentioned needs.

### SUMMARY OF THE INVENTION

The present invention relates to a tool box that comprises a base including multiple first inside walls to enclose a first room, and two of the multiple first inside walls face each other. Each of the two facing first inside walls includes multiple first pivots, and first ribs formed between adjacent first pivots. A second rib extends from each of the first pivots. A rack includes an end hole defined in each of two ends thereof. Each end hole includes multiple grooves located around the end hole, and the grooves communicate with the end hole. The grooves are located as a cross. The rack is pivotably connected between the two facing inside walls, wherein each of the end holes of the rack accommodates one of the first pivots, and the first and second ribs are engaged with the grooves of the end hole. A cover is pivotably mounted to the base.

The rack includes multiple partitions and each partition includes an open top. Each partition includes a lateral opening which communicates with the open top. A block is an elongate block and protrudes from the inner bottom of each partition and protrudes toward the open top. The block includes a distal section that is located opposite to the lateral opening corresponding thereto. The distal section includes an inclined top face. The top face faces the open top and is inclined downward toward a reception space thrilled between the distal section of the block and the inner bottom of the partition.

The primary object of the present invention is to provide a tool box that includes at least one rack pivotably connected between two facing inside walls of the base of the tool box. Each rack includes multiple partitions for accommodating bits and accessories. The at least one rack can be pivoted relative to the base so that the users are easily pick the bits and the accessories.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the tool box of the present invention;

FIG. 2 is another perspective view to show the tool box of the present invention;

FIG. 3 shows that the cover is opened relative to the base of the tool box of the present invention;

FIG. 4 is an exploded view of the tool box of the present invention;

FIG. 5 is a cross sectional view, taken along line V-V in FIG. 3;

FIG. 6 shows that the rack is pivoted relative to the base;

FIG. 7 shows that the tool box includes multiple racks;

FIG. 8 shows another embodiment of the rack;

FIG. 8-1 shows another perspective view of the rack disclosed in FIG. 8;

FIG. 9 is a cross sectional view, taken along line IX-IX in FIG. 8;

FIG. 10 shows that the bit is inserted upright into the reception space of the rack;

FIG. 10-1 shows that the bit is tilt and accessed from the lateral opening;

FIG. 11 shows that multiple tool boxes are piled up;

FIG. 12 is a cross sectional view, taken along line XII-XII in FIG. 11;

FIG. 13 shows that the cover is at its fully opened position relative to the base, and

FIG. 14 is another perspective view to show that the cover is at its fully opened position relative to the base.

### DETAILED DESCRIPTION OF THE PREFERRED EMBODIMENT

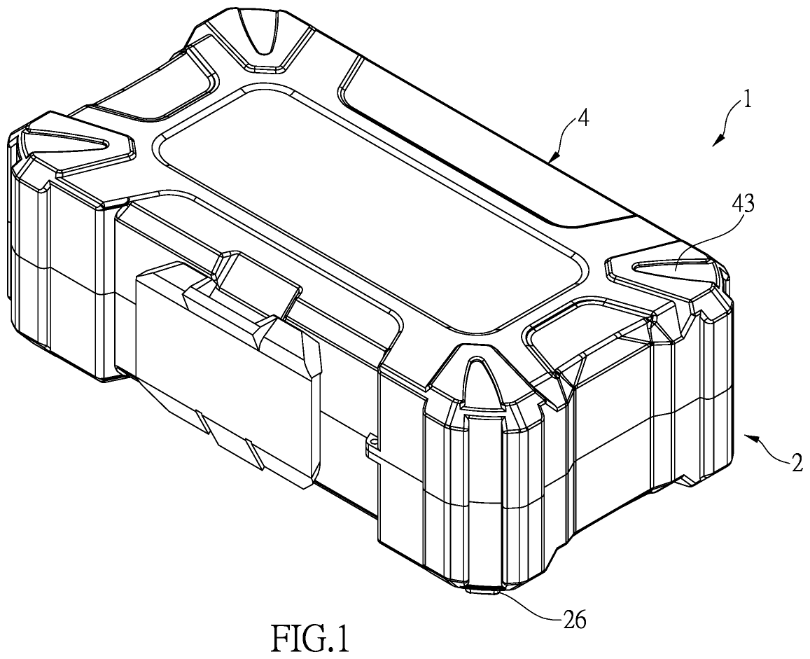

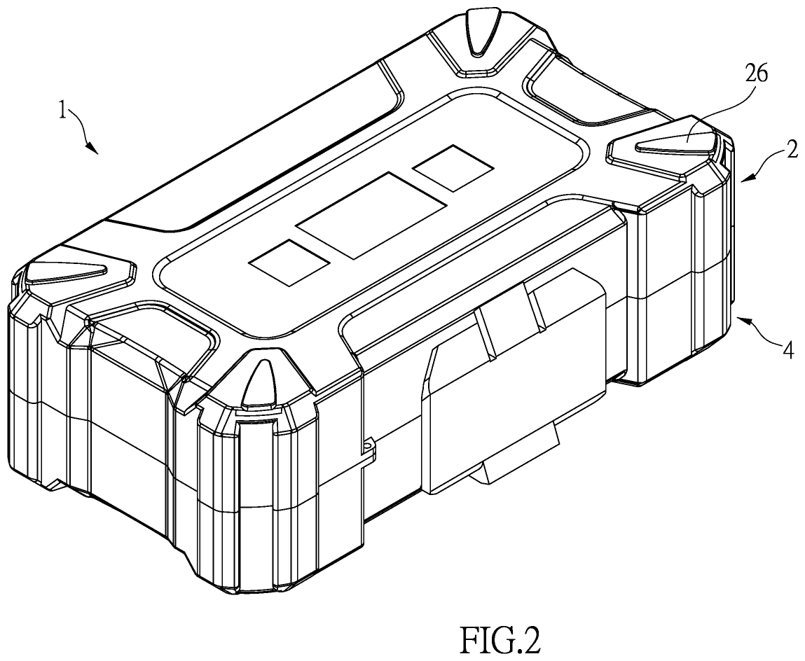

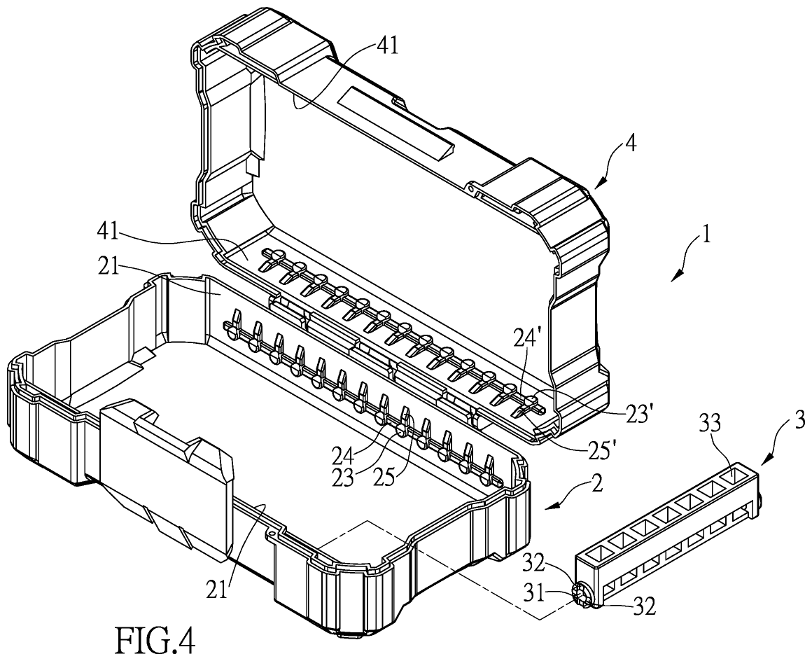

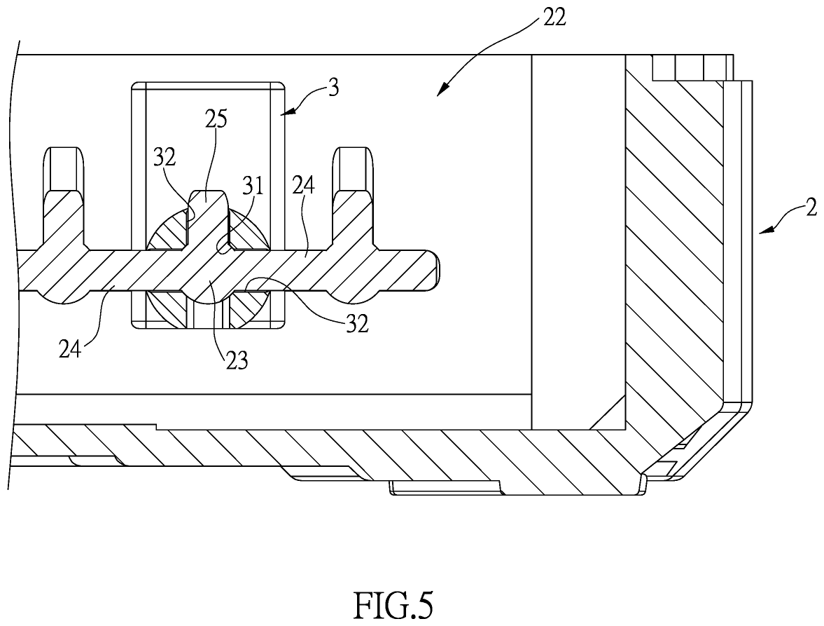

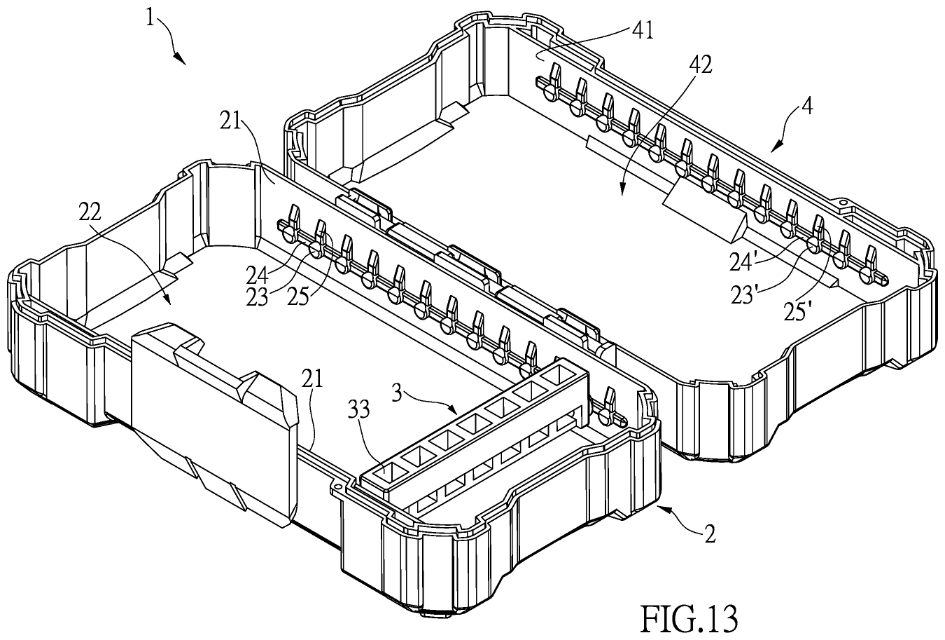

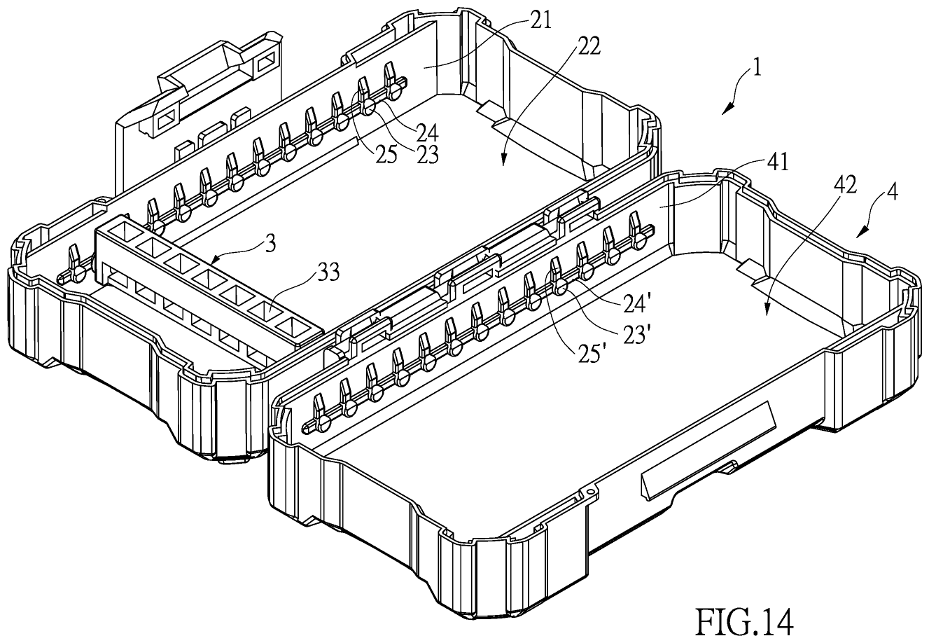

Referring to FIGS. 1 to 5, the tool box 1 of the present invention comprises a base 2 that includes multiple first inside walls 21 so as to enclose a first room 22. Two of the multiple first inside walls 21 face each other. As shown in FIGS. 13 and 14, each of the two facing first inside walls 21 includes multiple first pivots 23. First ribs 24 are formed between adjacent first pivots 23, and a second rib 25 extends from each of the first pivots 23. A rack 3 includes an end hole 31 defined in each of two ends thereof. Each end hole 31 includes multiple grooves 32 located around the end hole 31. The multiple grooves 32 communicate with the end hole 31. The grooves 32 are located as a cross. The rack 3 is pivotably connected between the two facing inside walls 21. Each of the end holes 31 of the rack 3 accommodates one of the first pivots 23, and the first and second ribs 24, 25 are engaged with the grooves 32 of the end hole 31. A cover 4 is pivotably mounted to the base 2.

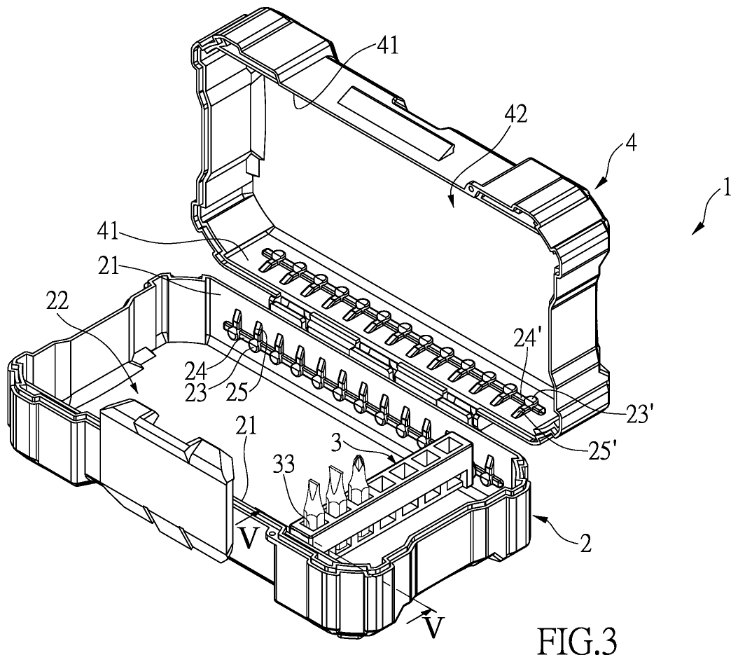

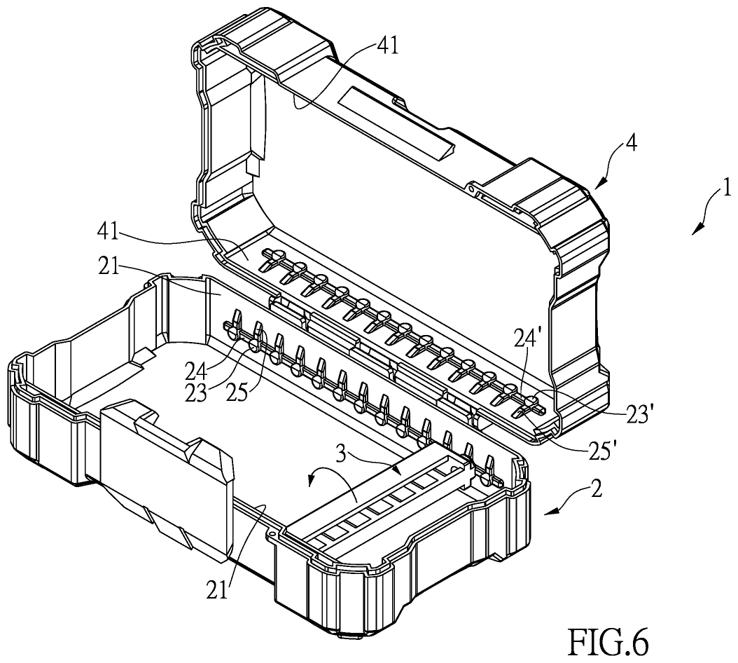

As shown in FIG. 3, the bits are organized by being inserted into the partitions 33 of the rack 3. As shown in FIG. 6, the rack 3 is pivotable relative to the base 2 so that when longer bits are inserted in the partitions 33, the cover 4 can be mounted to the base 2.

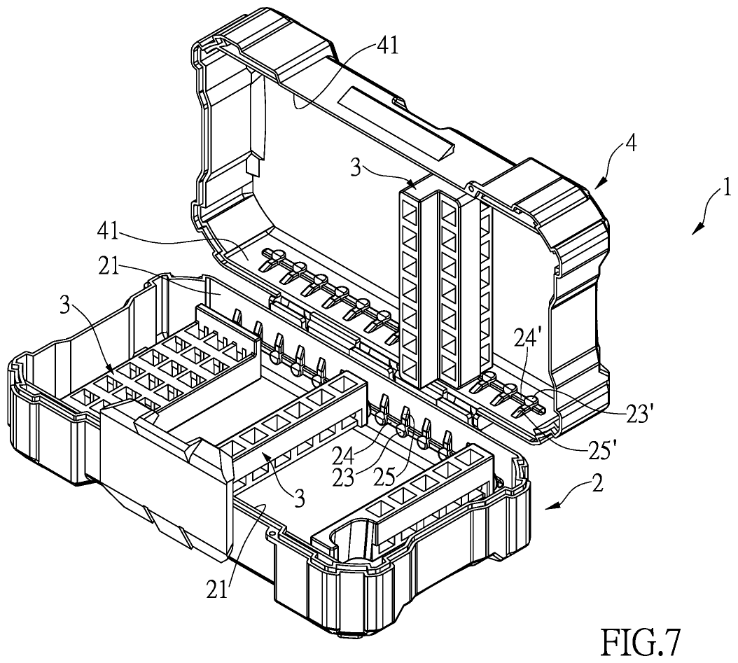

As shown in FIG. 7, the multiple pivots 23 on the two facing first inside walls 21 allow multiple racks 3 to be connected to the base 2. The distance between the racks 3 can also be adjusted according to needs.

The cooperation between first ribs 24, the second ribs 25 and the grooves 32 help to position the rack 3 when the rack 3 is pivoted, so that the rack 3 does not shift or rotate by impact. Besides, the grooves 32 are formed to the rack 3 so that when the grooves 32 are worn after a period of use, a new rack 3 is replaced, instead of replacement of the base 2.

The racks 3 can be installed to desired positions in the base 2 according the user's need so as to organize the bits and accessories.

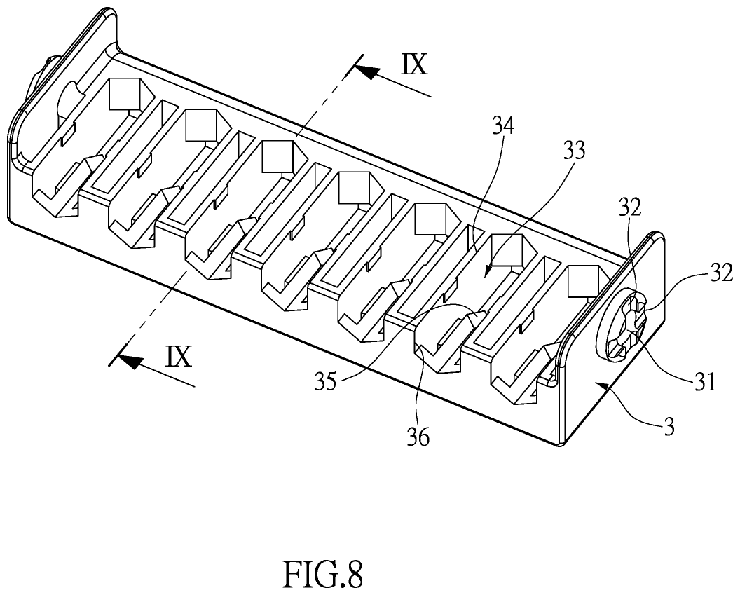

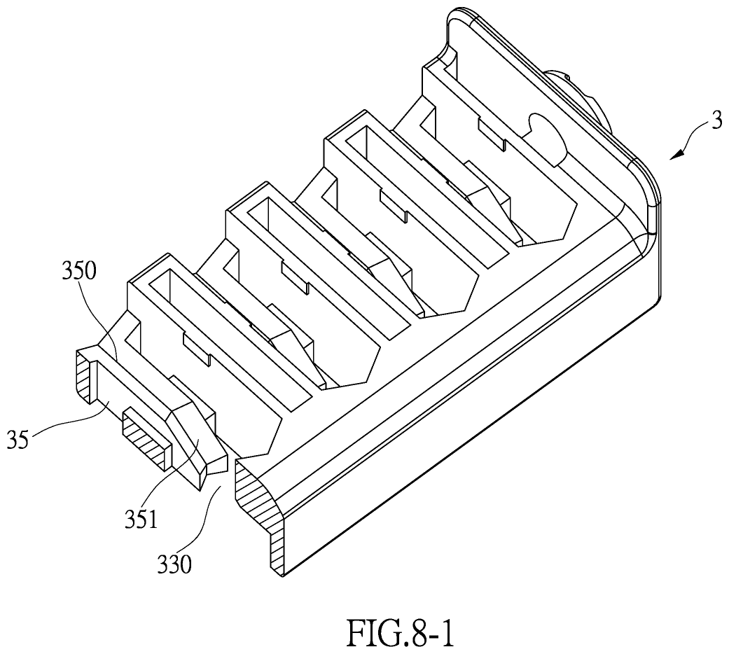

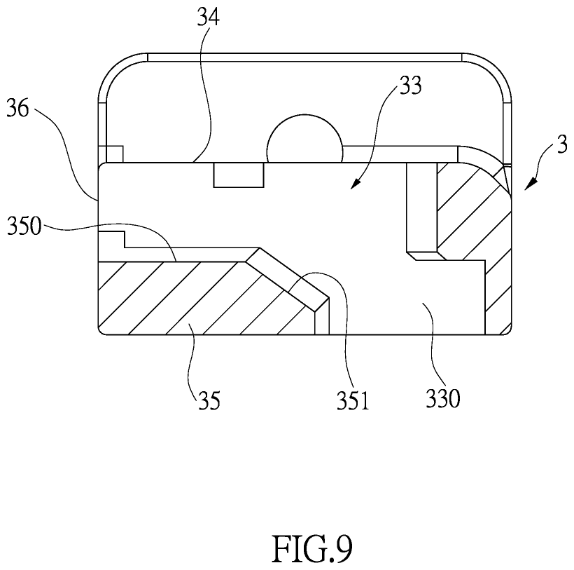

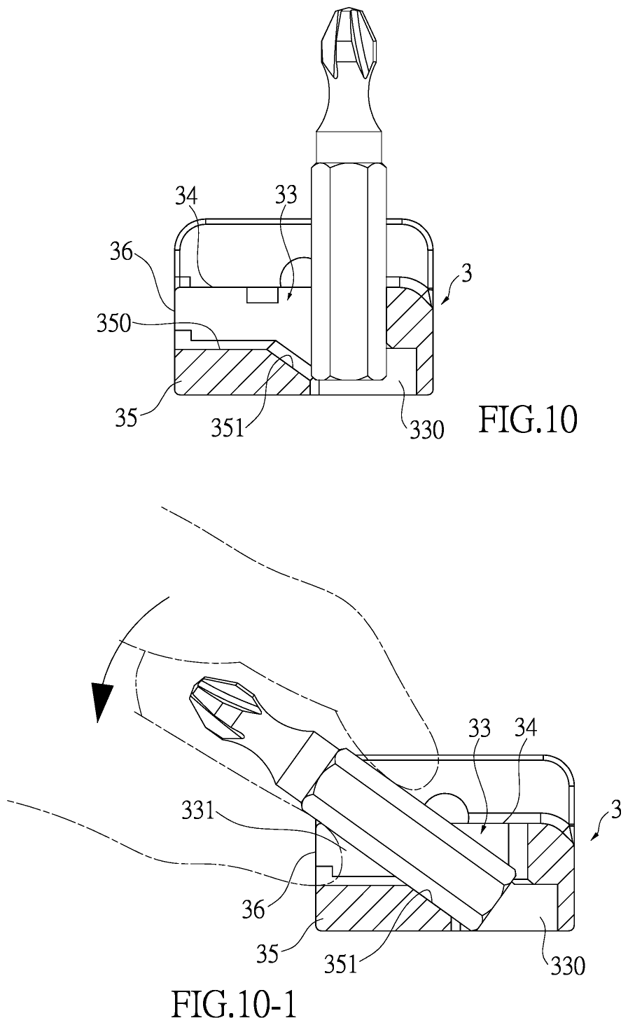

As shown In FIGS. 8, 8-1 and 9, the rack 3 includes multiple partitions 33, and each partition 33 includes an open top 34. Each partition 33 includes a lateral opening 36 which communicates with the open top 34. A block 35 is an elongate block and protrudes from the inner bottom of each partition 33, and protrudes toward the open top 34. The block 35 includes a V-shaped groove 350 defined in the top thereof, and the V-shaped groove 350 communicates with the lateral opening 36. That is to say, the lateral openings 36 each includes a V-shaped inner bottom which is formed by the V-shaped groove 350. The V-shaped groove 350 is used to accommodate side ridges on the shank of a bit. In addition, each block 35 includes a distal section that is located opposite to the lateral opening 36 corresponding thereto, and the distal section includes an inclined top face 351. The top face 351 of each block 35 faces the open top 34 and inclined downward toward a reception space 330 formed between the distal section of the block 35 and the inner bottom of each partition 33. As shown in FIG. 10, the shank of the bit is inserted into the reception space 330 when the bit is positioned upright as shown in FIG. 10. As shown in FIG. 10-1, the bit can be positioned at an angle, wherein the shank is rested on the top face 351 of the bock 35, the top face 351 of the distal section of the block 35 is located at a distance from the lateral opening 36 so that there is a space 331 formed between the shank and the block 35. The space 331 communicates with the lateral opening 36. The user can easily pick the bit by inserting a finger into the shape 331 via the lateral opening 36. The tilt bit prevents from being interfered with the bits of the next rack 3. The lateral opening 36 allows the bit to be positioned tilt as shown in FIG. 10-1. The reception space 330 formed between the distal section of the block 35 and the inner bottom of each partition 33 allows a longer bit to be inserted into the partition 33 upward.

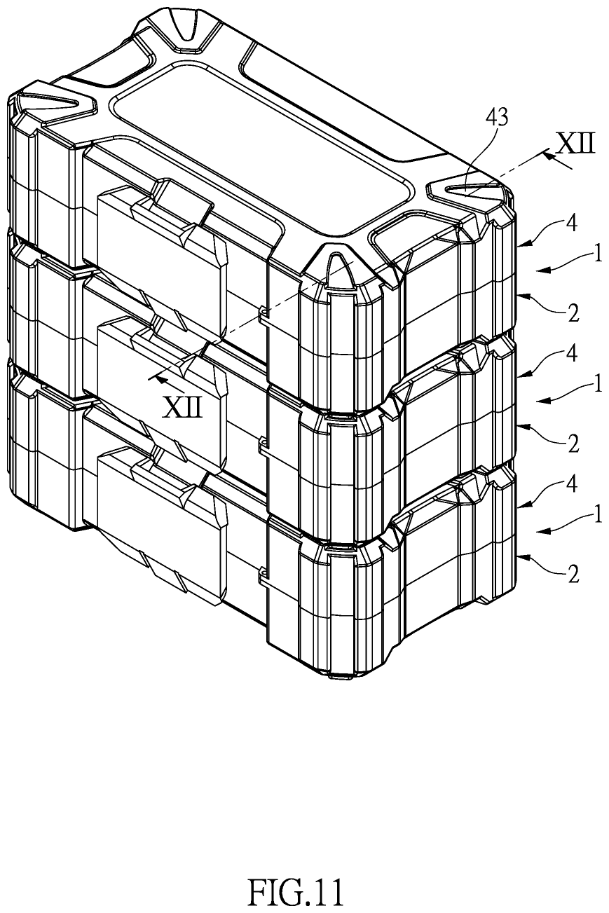

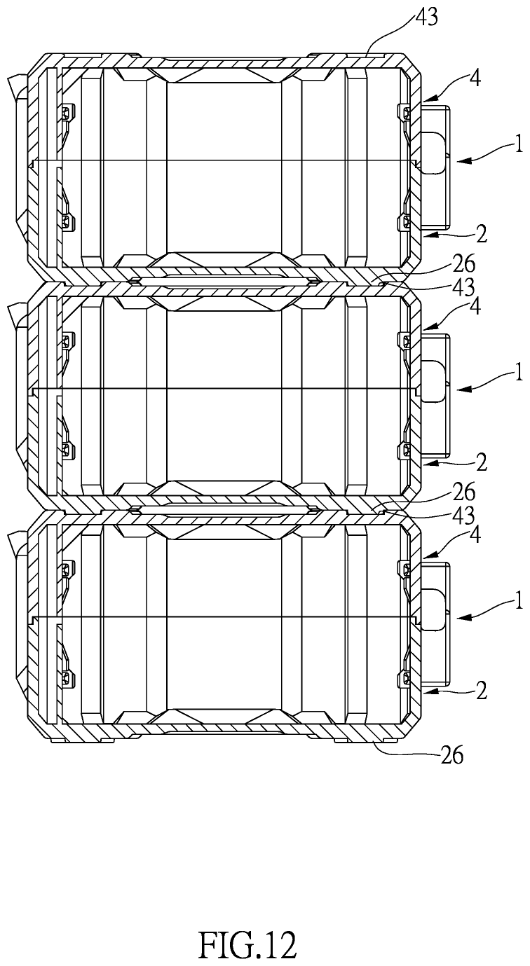

As shown in FIGS. 11 and 12, the cover 4 includes multiple recesses 43 defined in the top surface thereof. The base 2 includes multiple legs 26 protruding from the underside thereof. When two tool boxes 1 are piled up, the legs 26 of the base 2 of one of the two tool boxes 1 are accommodated in the recesses 43 of the cover 4 of another one of the two tool boxes 1. The piled tool boxes 1 are stably piled and do not separate from each other. As shown in FIGS. 3, 13 and 14, the cover 4 includes multiple second inside walls 41 which enclose a second room 42. Two of the multiple second inside walls 41 face each other. Each of the two facing second inside walls 41 includes multiple second pivots 23′. Multiple third ribs 24′ are formed between adjacent second pivots 23′. A fourth rib 25′ extends from each of the second pivots 23′. By the specific structure, as shown in FIG. 7, the racks 3 can also be connected to the cover 4 to receive more bits and accessories.

While we have shown and described the embodiment in accordance with the present invention, it should be clear to those skilled in the art that further embodiments may be made without departing from the scope of the present invention.

What is claimed is:

1. A tool box (1) comprising:
a base (2) including multiple first inside walls (21) which enclose a first room (22), two of the multiple first inside walls (21) facing each other, each of the two facing first inside walls (21) including multiple first pivots (23), and first ribs (24) formed between adjacent first pivots (23), a second rib (25) extending from each of the first pivots (23);
a rack (3) including an end hole (31) defined in each of two ends thereof, each end hole (31) including multiple grooves (32) located around the end hole (31), the multiple grooves (32) communicating with the end hole (31), the grooves (32) being located as a cross, the rack (3) pivotably connected between the two facing inside wails (21), each of the end holes (31) of the rack (3) accommodate one of the first pivots (23), and the first and second ribs (24, 25) engaged with the grooves (32) of the end hole (31), and a cover (4) pivotably mounted to the base (2), and
the rack (3) including multiple partitions (33) and each partition (33) including an open top (34), each partition (33) including a lateral opening (36) which communicates with the open top (34), a block (35) being an elongate block and protruding from an inner bottom of each partition (33) and protruding toward the open top (34), the block (35) including a distal section thin is located opposite to the lateral opening (36) corresponding thereto, the distal section including an inclined top face (351), the top face (351) facing the open top (34) and being inclined downward toward a reception space (330) formed between the distal section of the block (35) and the inner bottom of the partition (33).

2. The tool box as claimed in claim 1, wherein the top face (351) of the distal section of the block (35) is located at a distance from the lateral opening (36), when a bit is positioned at an angle by resting a shank of the bit on the top face (351) of the bock (35), a space (331) is formed between the shank of the bit and the block (35), and the space (331) communicates with the lateral opening (36).

3. The tool box as claimed in claim 1, wherein the cover (4) includes multiple recesses (43) defined in a top surface thereof, the base (2) includes multiple legs (26) extending from an underside thereof, when two tool boxes (1) are piled up, the legs (26) of the base (2) of one of the two tool boxes (1) are accommodated in the recesses (43) of the cover (4) of another one of the two tool boxes (1).

4. The tool box as claimed in claim 1, wherein the cover (4) includes multiple second inside walls (41) which enclose a second room (42), two of the multiple second inside walls (41) face each other, each of the two facing second inside walls (41) includes multiple second pivots (23′), and third ribs (24′) formed between adjacent second pivots (23′), a fourth rib (25′) extends from each of the second pivots (23′).
